(19) United States
(12) Patent Application Publication
(10) Pub. No.: US 2020/0140745 A1
(43) Pub. Date: May 7, 2020

(54) Emulsion-Based Breaker for Nanoparticle Clay Fluid

(71) Applicant: Halliburton Energy Services, Inc., Houston, TX (US)

(72) Inventors: Prashant D. Chopade, Kingwood, TX (US); Dipti Singh, Kingwood, TX (US)

(73) Assignee: Halliburton Energy Services, Inc., Houston, TX (US)

(21) Appl. No.: 16/345,589

(22) PCT Filed: Nov. 29, 2016
(86) PCT No.: PCT/US2016/064038

§ 371 Date: Apr. 26, 2019

(51) Int. Cl. C09K 8/64; C09K 8/80; C09K 8/70; C09K 8/60; C09K 8/565; C09K 8/72

(52) U.S. Cl. CPC C09K 8/64; C09K 8/80; C09K 8/70; C09K 2208/26; C09K 8/565; C09K 8/72; C09K 2208/10; C09K 8/607

(57) ABSTRACT

A method of treating in a subterranean formation including forming an acid internal/oil external emulsified fluid, wherein the emulsified fluid comprises an oil based fluid, an aqueous fluid, an emulsifier, and an acid; forming a nanoparticle clay fluid, wherein the fluid comprises a nanoparticle clay, a gelling agent, and a crosslinking agent; combining the emulsified fluid and the nanoparticle clay fluid to form a treatment fluid; introducing the treatment fluid into the subterranean formation; breaking the acid internal/oil external emulsion fluid portion of the treatment fluid, thereby releasing the acid; and breaking the nanoparticle clay fluid portion of the treatment fluid with the released acid. Treatment fluids include an acid internal/oil external emulsified fluid, wherein the emulsified fluid comprises an oil based fluid, an aqueous fluid, an emulsifier, and an acid; and a nanoparticle clay fluid, wherein the fluid comprises a nanoparticle clay, a gelling agent, and a crosslinking agent.

### BACKGROUND

The present invention generally relates to the use of breakers in subterranean operations, and, more specifically, to oil-external emulsified fluid systems, and methods of using these fluid systems as a breaker for clay nanoparticle-based fluids in subterranean operations.

Subterranean wells (e.g., hydrocarbon fluid producing wells and water producing wells) are often stimulated by hydraulic fracturing treatments. In a typical hydraulic fracturing treatment, a treatment fluid is pumped into a wellbore in a subterranean formation at a rate and pressure above the fracture gradient of the particular subterranean formation so as to create or enhance at least one fracture therein. Particulate solids (e.g., graded sand, bauxite, ceramic, nut hulls, and the like), or “proppant particulates,” are typically suspended in the treatment fluid or a second treatment fluid and deposited into the fractures while maintaining pressure above the fracture gradient. The proppant particulates are generally deposited in the fracture in a concentration sufficient to form a tight pack of proppant particulates, or “proppant pack,” which serves to prevent the fracture from fully closing once the hydraulic pressure is removed. By keeping the fracture from fully closing, the interstitial spaces between individual proppant particulates in the proppant pack form conductive pathways through which produced fluids may flow.

In traditional hydraulic fracturing treatments, the specific gravity of the proppant particulates may be high in relation to the treatment fluids in which they are suspended for transport and deposit in a target interval (e.g., a fracture). Therefore, the proppant particulates may settle out of the treatment fluid and fail to reach the target interval. For example, where the proppant particulates are to be deposited into a fracture, the proppant particulates may settle out of the treatment fluid and accumulate only or substantially at the bottommost portion of the fracture, which may result in complete or partial occlusion of the portion of the fracture where no proppant particulates have collected (e.g., at the top of the fracture). As such, fracture conductivity and production over the life of a subterranean well may be substantially impaired if proppant particulates settle out of the treatment fluid before reaching their target interval within a subterranean formation.

In many cases, treatment fluids can be utilized in a gelled state when performing a treatment operation. For example, in a fracturing operation, a treatment fluid can be gelled to increase its viscosity and improve its ability to carry a proppant or other particulate material. In other cases, a gelled treatment fluid can be used to temporarily divert or block the flow of fluids within at least a portion of a subterranean formation. In the case of fracturing operations, the gelled treatment fluid typically spends only a very short amount of time downhole before the gel is broken and the treatment fluid is produced from the wellbore. In fluid diversion or blocking operations, the gel typically needs to remain in place only for a short amount of time while another treatment fluid is flowed elsewhere in the subterranean formation.

When conducting subterranean operations, it can sometimes become necessary to block the flow of fluids in the subterranean formation for a prolonged period of time, typically for at least about one day or more. In some cases, the period of time can be much longer, days or weeks. For example, it can sometimes be desirable to impede the flow of formation fluids for extended periods of time by introducing a kill pill or perforation pill into the subterranean formation to at least temporarily cease the communication between wellbore and reservoir. As used herein, the terms “kill pill” and “perforation pill” refer to a small amount of a treatment fluid introduced into a wellbore that blocks the ability of formation fluids to flow into the wellbore. In kill pill and perforation pill applications, high density brines can be particularly effective as a carrier fluid, since they can form a highly viscous gel that blocks the flow of fluids within the wellbore by exerting hydrostatic pressure therein. Likewise, in fluid loss applications, it can sometimes be desirable to form a barrier within the wellbore that persists for an extended period of time.

For subterranean operations requiring extended downhole residence times, many gelled treatment fluids can prove unsuitable since they can break before their intended downhole function is completed. The premature break of gelled treatment fluids can be particularly problematic in high temperature subterranean formations (e.g., formations having a temperature of about 275° F. or above), where the elevated formation temperature decreases the gel stability and speeds gel decomposition. As subterranean operations are being conducted in deeper wellbores having ever higher formation temperatures, the issues with long-term gel stability are becoming an increasingly encountered issue as existing gels are being pushed to their chemical and thermal stability limits.

Traditionally, the decomposition of a gel, such as a gelled nanoparticle clay fluid, into lower viscosity fluids may be accomplished by using a breaker. An external breaker may be needed to remove a fracturing fluid upon well completion. Breaker compounds useful in high temperature formations may have high corrosion rates and may be harmful to the formation. Nanoparticle clay fluids may be broken almost instantly by dilute acids, but the breaking may cause the particulates to settle out before they have reached their target interval. Controlled breaking of these fluid systems is challenging, and thus there is a need for a system allowing the consistent controlled breaking of nanoparticle clay fluids.

### BRIEF DESCRIPTION OF THE DRAWINGS

The following figures are included to illustrate certain aspects of the present invention, and should not be viewed as exclusive embodiments. The subject matter disclosed is capable of considerable modification, alteration, and equivalents in form and function, as will occur to one having ordinary skill in the art and having the benefit of this disclosure.

FIG. 1 illustrates the structure of acid-internal oil-external emulsion droplets present in fluids of embodiments of the disclosure.

FIG. 2 depicts an embodiment of a system configured for delivering the fluids of the embodiments described herein to a downhole location.

FIG. 3A is a graph of viscosity and temperature vs. time comparing conventional fluids and fluids according to the disclosure.

FIG. 3B is a photograph of a conventional gel in a broken state used in the plot in FIG. 3A.

FIG. 3C is a photograph of a crosslinked gel in an unbroken state according to fluids of the disclosure and used in the plot in FIG. 3A.

FIGS. 4A-4D are photographs showing a static break test at various times for the fluids according to the disclosure.

### DETAILED DESCRIPTION

Embodiments of the invention are directed to oil-external emulsion fluid systems including an acid-based emulsion that may be used as a controlled breaker for nanoparticle clay fluids. The term “break” (and its derivatives) as used herein refers to a reduction in the viscosity of the fracturing fluid, e.g., by the breaking or reversing of the crosslinks between polymer molecules, or some breaking of the gelling agent polymers. No particular mechanism is implied by the term.

Nanoparticle clay fluids can be broken by dilute acids, however, the breaking occurs instantly upon contact with acid. To alleviate this instant breaking problem, encapsulating an ‘active’ acid ingredient is performed. Oil-external emulsions prepared using acid as an internal phase provide encapsulated acids in the form of droplets stabilized by emulsifier. FIG. 1 illustrates the structure of an acid-internal oil-external emulsion droplet.

The acid-emulsion may be mixed in with the nanoparticle clay fluid at the surface. At downhole temperatures, the acid-emulsion breaks slowly, releasing the acid to break the nanoparticle clay fluid.

### General Measurement Terms and Definitions

Unless otherwise specified or unless the context otherwise clearly requires, any ratio or percentage means by volume.

If there is any difference between U.S. or Imperial units, U.S. units are intended.

Unless otherwise specified, mesh sizes are in U.S. Standard Mesh.

The micrometer (μm) may sometimes be referred to herein as a micron.

The conversion between pound per gallon (lb/gal or ppg) and kilogram per cubic meter (kg/m³) is: 1 lb/gal=(1 lb/gal)×(0.4536 kg/lb)×(gal/0.003785 m³)=119.8 kg/m³.

As used herein, into a subterranean formation can include introducing at least into and/or through a wellbore in the subterranean formation. According to various techniques known in the art, equipment, tools, or well fluids can be directed from a wellhead into any desired portion of the wellbore. Additionally, a well fluid can be directed from a portion of the wellbore into the rock matrix of a zone.

Broadly, a zone refers to an interval of rock along a wellbore that is differentiated from surrounding rocks based on hydrocarbon content or other features, such as perforations or other fluid communication with the wellbore, faults, or fractures. A treatment usually involves introducing a treatment fluid into a well. As used herein, a treatment fluid is a fluid used in a treatment. Unless the context otherwise requires, the word treatment in the term “treatment fluid” does not necessarily imply any particular treatment or action by the fluid. If a treatment fluid is to be used in a relatively small volume, for example less than about 200 barrels, it is sometimes referred to in the art as a slug or pill. As used herein, a treatment zone refers to an interval of rock along a wellbore into which a treatment fluid is directed to flow from the wellbore. Further, as used herein, into a treatment zone means into and through the wellhead and, additionally, through the wellbore and into the treatment zone.

As used herein, the term “controlled breaking” generally refers to methods of breaking in which breaking of fracturing fluid has been delayed at least for about an hour. Controlled breaking may occur in a variety of ways. For example, the kinetic rate of breaking may be delayed (e.g., by controlling temperature and/or concentration) or preferably, the release of a breaker may be delayed (i.e., controlled release of a breaker encapsulated by an encapsulant). The encapsulants are essentially protective coatings that are thermally stable and do not readily degrade until required. The nature (e.g., length) of the delay will depend largely on the specific breaker, the encapsulant and concentration used. The controlled release of breakers may occur through a number of mechanisms involving the removal of encapsulant including, but are not limited to, degradation, biodegradation, solvation, and the like. In some cases, the release of breaker may also occur by diffusion without removal of encapsulant. In some cases, the delay may correspond to a certain event (e.g., once fracturing fluid is spent) at which point a reduction in viscosity may be desirable.

The delayed acid breaker is introduced into a subterranean formation. The subterranean formation can be penetrated by a wellbore. A fluid, such as a drilling fluid, can be introduced into the wellbore. The fluid can form a filtercake on the wall of the wellbore. The fluid can also form a filtercake a certain distance into the subterranean formation from the wellbore, such as a few feet into any pores of the subterranean formation. In this manner, the filtercake that is formed is not restricted to just the wall of the wellbore, but rather, can penetrate a certain distance into the subterranean formation. The filtercake that is formed can be degraded by the acid. For example, some or all of the ingredients that make up the filtercake can be acid-soluble. In this manner, some or all of the filtercake can be degraded (including dissolved or broken down molecularly into smaller fragments) such that degraded filtercake can be removed from the subterranean formation via the wellbore. Preferably, the acid degrades all of the filtercake such that the permeability of the subterranean formation is restored to a pre-filtercake state. Accordingly, the degraded filtercake does not leave any residue on surfaces of the subterranean formation or wellbore. According to certain embodiments, the delayed acid breaker also does not leave a substantial amount of residue such that the permeability of the formation is affected.

In certain embodiments of the present invention, a method of treating in a subterranean formation comprises: forming an acid internal/oil external emulsified fluid, wherein the emulsified fluid comprises an oil based fluid, an aqueous fluid, an emulsifier, and an acid; forming a nanoparticle clay fluid, wherein the fluid comprises a nanoparticle clay, a gelling agent, and a crosslinking agent; combining the emulsified fluid and the nanoparticle clay fluid to form a treatment fluid; and introducing the treatment fluid into the subterranean formation; breaking the acid internal/oil external emulsion fluid portion of the treatment fluid, thereby releasing the acid; and breaking the nanoparticle clay fluid portion of the treatment fluid with the released acid.

Wellbore treatment fluids according to this disclosure comprise an acid internal/oil external emulsified fluid, wherein the emulsified fluid comprises an oil based fluid, an aqueous fluid, an emulsifier, and an acid; and a nanoparticle clay fluid, wherein the fluid comprises a nanoparticle clay, a gelling agent, and a crosslinking agent.

Aqueous Base Fluid

As used herein, the term ‘aqueous fluid’ refers to a material comprising water or a water-miscible but oleaginous fluid-immiscible compound. The aqueous fluid or base fluid of the present embodiments can generally be from any source, provided that the fluids do not contain components that might adversely affect the stability and/or performance of the wellbore treatment fluids of the present disclosure. Illustrative aqueous fluids suitable for use in embodiments of this disclosure include, but are not limited to, fresh water, sea water, a brine containing at least one dissolved organic or inorganic salt, a liquid containing water-miscible organic compounds, and the like.

In some embodiments, the aqueous fluid can comprise a monovalent brine or a divalent brine. Suitable monovalent brines can include, for example, sodium chloride brines, sodium bromide brines, potassium chloride brines, potassium bromide brines, and the like. Suitable divalent brines can include, for example, magnesium chloride brines, calcium chloride brines, calcium bromide brines, and the like. In some embodiments, the aqueous base fluid can be a high density brine. As used herein, the term ‘high density brine’ refers to a brine that has a density of about 9.5-10 lbs/gal or greater (1.1 g/cm³-1.2 g/cm³ or greater).

Oil Base Fluid

A wellbore treatment fluid of this disclosure comprises an oil phase. In embodiments, a wellbore treatment fluid according to this disclosure comprises an oil-external phase. The oil phase comprises an oleaginous fluid, which may include one or more hydrocarbon. As used herein, the term ‘oleaginous fluid’ refers to a material having the properties of an oil or like non-polar hydrophobic compound. Illustrative oleaginous fluids suitable for use in embodiments of this disclosure include, for example, (i) esters prepared from fatty acids and alcohols, or esters prepared from olefins and fatty acids or alcohols; (ii) linear alpha olefins, isomerized olefins having a straight chain, olefins having a branched structure, isomerized olefins having a cyclic structure, and olefin hydrocarbons; (iii) linear paraffins, branched paraffins, poly-branched paraffins, cyclic paraffins and isoparaffins; (iv) mineral oil hydrocarbons; (v) glyceride triesters including, for example, rapeseed oil, olive oil, canola oil, castor oil, coconut oil, corn oil, cottonseed oil, lard oil, linseed oil, neatsfoot oil, palm oil, peanut oil, perilla oil, rice bran oil, safflower oil, sardine oil, sesame oil, soybean oil and sunflower oil; (vi) naphthenic compounds (cyclic paraffin compounds having a formula of CₙH₂ₙ where n is an integer ranging between about 5 and about 30); (vii) diesel; (viii) aliphatic ethers prepared from long chain alcohols; and (ix) aliphatic acetals, dialkylcarbonates, and mixtures thereof. As used herein, fatty acids and alcohols or long chain acids and alcohols refer to acids and alcohols containing about 6 to about 22 carbon atoms, or about 6 to about 18 carbon atoms, or about 6 to about 14 carbon atoms. In some embodiments, such fatty acids and alcohols have about 6 to about 22 carbon atoms comprising their main chain. One of ordinary skill in the art will recognize that the fatty acids and alcohols may also contain unsaturated linkages.

In embodiments, in a wellbore treatment fluid according to this disclosure, an oleaginous fluid external phase and an aqueous fluid internal phase are present in a ratio of less than about 50:50. This ratio is commonly stated as the oil-to-water ratio (OWR). That is, in the present embodiments, a wellbore treatment fluid having a 50:50 OWR comprises 50% oleaginous fluid external phase and 50% aqueous fluid internal phase. In embodiments, treatment fluid according to this disclosure have an OWR ranging between about 1:99 to about 99:1, including all sub-ranges therein between. In embodiments, treatment fluid according to this disclosure have an OWR ranging between about 1:99 to about 35:65, including all sub-ranges therein between. In embodiments, treatment fluid of this disclosure have an OWR ranging between about 1:99 and about 10:90, including all sub-ranges therein between. In embodiments, the treatment fluids have an OWR of about 10:90 or less. In embodiments, the treatment fluids have an OWR of about 5:95 or less. One of ordinary skill in the art will recognize that lower OWRs can more readily form emulsions that are suitable for suspending sand and other proppants therein. However, one of ordinary skill in the art will also recognize that an OWR that is too low may prove overly viscous for downhole pumping.

In embodiments, an oil-external emulsion treatment fluid according to this disclosure comprises a less than conventional volume percentage of oil. For example, in embodiments, a wellbore treatment fluid according to this disclosure comprises from about 1 to about 10, from about 2 to about 9, or from about 3 to about 8 volume percent oil, based on the total volume of the treatment fluid. In embodiments, a wellbore treatment fluid according to this disclosure comprises less than or equal to about 30, 25, 20, 15, 10, 9, 8 7, 6, 5, 4, or 3 volume percent oil, based on the total volume of the treatment fluid.

Acids

The breakers of the disclosure include an acid encapsulated as the internal phase of the treatment fluids, and stabilized by emulsifiers. Useful acids include any that may be encapsulated as the internal phase of the treatment fluid. The encapsulation is typically performed by mixing aqueous acid and oil in desired ratios in presence of suitable surfactant. Typically, high shear mixing conditions are required to form an emulsion. Suitable acids may include, but are not limited to, organic acids or salts, such as citric acid or a citrate, fumaric acid, glycolic acid, salicylic acid, maleic acid, acetic acid, propionic acid, butanoic acid, pentanoic acid, hexanoic acid, heptanoic acid, octanoic acid, nonanoic acid, decanoic acid, dodecanoic acid, palmitic acid, stearic acid, and combinations thereof. Additional carboxylic acids that may be useful are sebacic acid, phthalic acid, isophthalic acid, terephthalic acid, adipic acid, pamoic acid, suberic acid, succinic acid, traumatic acid, thapsic acid, valporic acid, and combinations thereof.

In certain embodiments, the acid source may comprise complexing and chelating agents that are soluble in the internal phase such as HEDTA, GLDA, MGDA, HIDS, EDDS, IDA, phosphonic acids, citric acid, glycolic acid, malonic acid, gluconic acid, lactic acid, methane sulfonic acid, fluoroboric acid, hydrochloride salts such as urea hydrochloride, glycine hydrochloride. In certain embodiments, the acid has a pKₐ from about −3.0 to about 5.5. Additional useful acids include, but are not limited to, N-Phosphonomethyl Iminodiacetic Acid (PMIDA), organic and inorganic acids such as sulfonated esters, phosphate esters, organo orthoformate, organo orthoacetate, triethyl citrate and combinations thereof.

Acids of the disclosure may be present in the amount of about 1 gal/1000 gal to about 100 gal/1000 gal of the acid internal/oil external emulsified fluid. A preferred range is about 5 gal/1000 gal to about 30 gal/1000 gal.

Nanoparticle Clays

Viscosifiers are typically added to increase the viscosity of the fluid to facilitate or enhance suspension of weighting agents in the fluid. Organoclays, such as for example bentonites, hectorites and other swelling clays, chemically treated to enhance their oil wettability, are typical viscosifiers. Organic polymers and long chain fatty acids may also be added to increase viscosity and aid weighting agent suspension.

The treatment fluids of the disclosure include a nanoparticle clay. The nanoparticle clay fluid component of the treatment fluids may include a nanoparticle clay, a gelling agent, and a crosslinking agent. The nanoparticles can include silicates and phyllosillicates including hectorite, bentonite, montmorillonite, beidellite and combinations thereof. An exemplary nanoparticle includes the clay known by the trade name Laponite™, which is commercially available from BYK Additives Inc. (formerly Rockwood Additives). Laponite™, like other clays disclosed herein, can be used as a rheology modifier in aqueous solutions to impart thixotropic, shear sensitive viscosity and improve stability and syneresis control in certain commercial applications. In certain illustrative embodiments, the Laponite™ can be Laponite™ RD. Synthetic hectorite known as ThermaVis™ viscosifier, is sold by Halliburton Energy Services, Inc., Houston, Tex. Modified clays, such as hectorite, may have up to 10 times better swelling properties than bentonite.

The nanoparticle clays of the disclosure may be present in the amount of about 0.1 wt % to about 20 wt % of the nanoparticle clay fluid. In some embodiments, the nanoparticle clays are present in the amount of about 0.1 wt % to about 10 wt %, about 0.1 wt % to about 5 wt %, about 0.1 wt % to about 1 wt %, about 5 wt % to about 20 wt %, about 5 wt % to about 10 wt %, or about 10 wt % to about 20 wt % of the nanoparticle clay fluid.

Proppants

One component of the oil-external emulsions of the disclosure may include proppants. In some embodiments, the proppants may be an inert material, and may be sized (e.g., a suitable particle size distribution) based upon the characteristics of the void space to be placed in.

Materials suitable for proppant particulates may comprise any material comprising inorganic or plant-based materials suitable for use in subterranean operations. Suitable materials include, but are not limited to, sand; bauxite; ceramic materials; glass materials; nut shell pieces; cured resinous particulates comprising nut shell pieces; seed shell pieces; cured resinous particulates comprising seed shell pieces; fruit pit pieces; cured resinous particulates comprising fruit pit pieces, wood; hydrophobically modified proppant, inherently hydrophobic proppant, proppant with a hydrophobic coating, and combinations thereof. The mean proppant particulate size generally may range from about 2 mesh to about 400 mesh on the U.S. Sieve Series; however, in certain circumstances, other mean proppant particulate sizes may be desired and will be entirely suitable for practice of the embodiments disclosed herein. In particular embodiments, preferred mean proppant particulate size distribution ranges are one or more of 6/12, 8/16, 12/20, 16/30, 20/40, 30/50, 40/60, 40/70, or 50/70 mesh. It should be understood that the term “particulate,” as used herein, includes all known shapes of materials, including substantially spherical materials; fibrous materials; polygonal materials (such as cubic materials); and any combination thereof. In certain embodiments, the particulates may be present in the treatment fluids in an amount in the range of from an upper limit of about 30 pounds per gallon (“ppg”) (3600 kg/m³), 25 ppg (3000 kg/m³), 20 ppg (2400 kg/m³), 15 ppg (1800 kg/m³), and 10 ppg (1200 kg/m³) to a lower limit of about 0.5 ppg (60 kg/m³), 1 ppg (120 kg/m³), 2 ppg (240 kg/m³), 4 ppg (480 kg/m³), 6 ppg (720 kg/m³), 8 ppg (960 kg/m³), and 10 ppg (1200 kg/m³) by volume of the treatment fluids.

Coated Proppants

As used herein, the term “coating,” and the like, does not imply any particular degree of coating on a particulate. In particular, the terms “coat” or “coating” do not imply 100% coverage by the coating on a particulate. It should be understood that the term “particulate,” as used in this disclosure, includes all known shapes of materials, including substantially spherical materials, fibrous materials, polygonal materials (such as cubic materials), and combinations thereof.

The proppant coating may be applied by many techniques. In one embodiment, the polymer is applied by solution coating. In this process a polymer solution is prepared by mixing polymer into a solvent until a homogenous mixture is achieved. Proppant is added to solution, and the solvent is removed under vacuum using a rotary evaporator. The remaining proppant is adsorbed to proppant surface.

In an embodiment, a spray coating technique is used. Liquid polymer (or polymer solution) is sprayed onto the proppant substrate. The coated proppant is then dried to remove water or carrier fluids.

In various embodiments, the amount of coating on the proppants is about 0.1 wt. % to about 10 wt. % of the proppant substrate. In another embodiment, the amount of coating is the amount needed to produce a hydrophobic proppant particle.

Emulsifiers

The water-in-oil emulsion of the treatment fluid of the present disclosure further comprises an emulsifier. As used herein, an “emulsifier” refers to a type of surfactant that helps prevent the droplets of the dispersed phase of an emulsion from flocculating or coalescing in the emulsion. Examples of emulsifiers that may be suitable include, but are not limited to, emulsifiers with an HLB (Davies' scale) in the range of about 4 to about 12. Examples of suitable emulsifiers may include, but are not limited to, surfactants, proteins, hydrolyzed proteins, lipids, glycolipids, nanosized particulates (e.g., fumed silica), and combinations thereof. The emulisifier may be a polyaminated fatty acid.

An emulsifier or emulsifier package is preferably in a concentration of at least 0.1% by weight of the emulsion. More preferably, the emulsifier is in a concentration in the range of 0.1% to 10% by weight of the emulsion.

Gelling Agents

The charged polymeric gelling agent may be cationic or anionic. In preferred embodiments, the charged polymeric gelling agent is anionic. Examples of such suitable charged polymeric gelling agents for use in the methods and compositions of the present invention include, but are not limited to, a derivatized guar gum (e.g., carboxymethyl guar, carboxymethylhydroxyethyl guar, and carboxymethylhydroxypropyl guar (“CMHPG”)); a cellulose derivative (e.g., hydroxyethyl cellulose, carboxyethylcellulose, carboxymethylcellulose, and carboxymethylhydroxyethylcellulose); xanthan; succinoglycan; alginate; chitosan; any derivative thereof; and any combination thereof. The term “derivative” is defined herein any compound that is made from one of the listed compounds, for example, by replacing one atom in one of the listed compounds with another atom or group of atoms, ionizing one of the listed compounds, or creating a salt of one of the listed compounds. In some preferred embodiments, the charged polymeric gelling agent is a derivatized guar gum or a cellulose derivative. Examples of suitable commercially available charged polymeric gelling agents for use in the methods and compositions of the present invention include, but are not limited to, WG-39™ gelling agent and WG36™ gelling agent, available from Halliburton Energy Services, Inc., Houston, Tex. In some embodiments, the charged polymeric gelling agent of the present invention is present in an amount in the range of from about 1 pounds per thousand gallons (“ppt”) to about 100 ppt of the treatment fluid. In other embodiments, the charged polymeric gelling agent of the present invention is present in an amount in the range of from about 10 ppt to about 65 ppt of the treatment fluid. In other embodiments, the charged polymeric gelling agent of the present invention is present in an amount in the range of from about 20 ppt to about 65 ppt of the treatment fluid. The concentration of the charged polymeric gelling agent may be dependent upon a number of factors such as, for example, the type of polymeric gelling agent used, the salts present in the treatment fluid, the type of subterranean formation operation used, the conditions of the subterranean formation itself (e.g., pH, temperature, etc.), and the like. One of ordinary skill in the art, with the benefit of this disclosure, will recognize the appropriate concentration of the charged polymeric gelling agent to achieve a particular result.

Crosslinking Agents

In some embodiments, the charged polymeric gelling agents of the present invention may be additionally crosslinked. Such crosslinking may synergistically work with the charged polymeric gelling agent to enhance proppant suspension in the treatment fluid. Suitable crosslinking agents may include metal ions capable of crosslinking at least two molecules of the charged polymeric gelling agent. Examples of suitable crosslinking agents include, but are not limited to, borate ions; magnesium ions; zirconium IV ions; titanium IV ions; aluminum ions; antimony ions; chromium ions; iron ions; copper ions; zinc ions; and any combination thereof. These ions may be provided by providing any compound that is capable of producing one or more of these ions. Examples of such compounds include, but are not limited to, ferric chloride; boric acid; disodium octaborate tetrahydrate; sodium diborate; pentaborate; ulexite; colemanite; magnesium oxide; zirconium lactate; zirconium triethanol amine; zirconium lactate triethanolamine; zirconium carbonate; zirconium acetylacetonate; zirconium malate; zirconium citrate; zirconium diisopropylamine lactate; zirconium glycolate; zirconium triethanol amine glycolate; zirconium lactate glycolate; titanium lactate; titanium malate; titanium citrate; titanium ammonium lactate; titanium triethanolamine; titanium acetylacetonate; aluminum lactate; aluminum citrate; antimony compounds; chromium compounds; iron compounds; copper compounds; zinc compounds; and combinations thereof. In some embodiments, the metal ions used to crosslink the charged polymeric gelling agent of the present invention may be delivered as chelates. Suitable commercially available crosslinking agents for use in the methods and compositions of the present invention include, but are not limited to, CL-23™ crosslinking agent and BC140™ crosslinking agent available from Halliburton Energy Services, Inc., Houston, Tex. The crosslinking agent may be present in the treatment fluids of the present invention in an amount in the range of from about 0.1 gal/1000 gal to about 10 gal/1000 gal of the treatment fluid. In another embodiment, the crosslinker is present from about 0.1 gal/1000 gal to about 5 gal/1000 gal of the treatment fluid.

Buffering Agents

In some embodiments, a buffer may be included in the treatment fluids of the present invention to control the pH of the treatment fluid, such that the pH of the treatment fluid is in the range of from about 4 to about 8. In some preferred embodiments, a buffer may be included in the treatment fluids of the present invention such that the pH of the treatment fluid is in the range of from about 5 to about 7. Suitable buffers may include, but are not limited to, mixtures of a salt of a weak acid and an organic acid such as sodium carbonate and fumaric acid; sodium acetate and fumaric acid; ammonium acetate and acetic acid; sodium citrate and citric acid; and the like. An example of a suitable commercially available buffer includes, but is not limited to, BA-20™ buffering agent available from Halliburton Energy Services, Inc., Houston, Tex., which may maintain the pH of the treatment fluids of the present invention in the range of 4.5 to 6.5. The ratio of the salt and acid in the buffer can be varied to provide the desired buffered pH. The particular pH for a given treatment fluid will be recognized by one of skill in the art depending on particular factors such as, for example, the type of charged polymeric gelling agent used, the conditions (e.g., pH and temperature) of the subterranean formation being treated, the particular subterranean operation being performed, and the like.

In some embodiments, the treatment fluids and methods of the present invention do not use external breakers. If external breakers are utilized, they may include any of the following: an enzyme breaker; an oxidizing breaker; an acid breaker; a delayed breaker; or any combination thereof. The breakers may cause the treatment fluids of the present invention to become less viscous fluids that can more easily be produced back to the surface, for example, after they have been used to place proppant particles in subterranean fractures. In some embodiments, the breaker may be formulated to remain inactive until it is “activated” by, among other things, certain conditions in the fluid (e.g., pH, temperature, and the like) and/or interaction with some other substance. In some embodiments, the breaker may be delayed by encapsulation with a coating (e.g. a porous coatings through which the breaker may diffuse slowly, or a degradable coating that degrades downhole) that delays the release of the breaker. In other embodiments the breaker may be a degradable material (e.g. polylactic acid or polyglycolic acid) that releases an acid or alcohol in the present of an aqueous liquid. An example of a suitable commercially available breaker includes, but is not limited to, OptiFlo III™ breaker, available from Halliburton Energy Services, Inc., Houston, Tex., which is a delayed breaker having a permeable coating susceptible to elevated temperature. In certain embodiments, the breaker used may be present in the treatment fluids of the present invention in an amount in the range of from about 0.1 ppt to about 10 ppt by volume of the treatment fluid. One of ordinary skill in the art, with the benefit of this disclosure, will recognize the type and amount of a breaker to include in certain treatment fluids of the present invention based on, among other factors, the desired amount of delay time before breaking, the type of charged polymeric gelling agents used, the temperature conditions of a particular application, the pH of the first treatment fluid, and the like.

Other Additives

In addition to the foregoing materials, it can also be desirable, in some embodiments, for other components to be present in the treatment fluid. Such additional components can include, without limitation, surfactants, gelling agents, fluid loss control agents, corrosion inhibitors, rheology control modifiers or thinners, viscosity enhancers, temporary viscosifying agents, filtration control additives, high temperature/high pressure control additives, emulsification additives, surfactants, acids, alkalinity agents, pH buffers, fluorides, gases, nitrogen, carbon dioxide, surface modifying agents, tackifying agents, foamers, scale inhibitors, catalysts, clay control agents, biocides, bactericides, friction reducers, antifoam agents, bridging agents, dispersants, flocculants, H₂S scavengers, CO₂ scavengers, oxygen scavengers, friction reducers, breakers, relative permeability modifiers, resins, wetting agents, coating enhancement agents, filter cake removal agents, surfactants, defoamers, shale stabilizers, oils, and the like. One or more of these additives (e.g., bridging agents) may comprise degradable materials that are capable of undergoing irreversible degradation downhole. A person skilled in the art, with the benefit of this disclosure, will recognize the types of additives that may be included in the fluids of the present disclosure for a particular application, without undue experimentation.

Methods of Use

The methods of the present invention may be employed in any subterranean treatment where a viscoelastic treatment fluid may be used. Suitable subterranean treatments may include, but are not limited to, drilling, fracturing treatments, sand control treatments (e.g., gravel packing), and other suitable treatments where a treatment fluid of the present invention may be suitable.

In addition to the fracturing fluids used in fracturing treatments, other fluids used in servicing a wellbore may also be lost to the subterranean formation while circulating the fracturing fluids in the wellbore. In particular, the other fluids may enter the subterranean formation via lost circulation zones for example, depleted zones, zones of relatively low pressure, zones having naturally occurring fractures, weak zones having fracture gradients exceeded by the hydrostatic pressure of the drilling fluid, and so forth.

A method of treating in a subterranean formation comprising: forming an acid internal/oil external emulsified fluid, wherein the emulsified fluid comprises an oil based fluid, an aqueous fluid, an emulsifier, and an acid; forming a nanoparticle clay fluid, wherein the fluid comprises a nanoparticle clay, a gelling agent, and a crosslinking agent; combining the emulsified fluid and the nanoparticle clay fluid to form a treatment fluid; introducing the treatment fluid into the subterranean formation; breaking the acid internal/oil external emulsion fluid portion of the treatment fluid, thereby releasing the acid; and breaking the nanoparticle clay fluid portion of the treatment fluid with the released acid. The breaking may occur within about 1 hour of placing the fluid in the wellbore. The breaking time may also occur within about 2, 3, 4, 5, 6, 7, 8, 9, 10, 11, 12, 13, 14, 15, 26, 17, 18, 19, 20, 21, 22 23, or 24 hours of placing the fluid in the wellbore.

In some embodiments, the present treatment fluids can be used in a subterranean formation having a temperature of up to about 350° F. In some embodiments, the present treatment fluids can be used in a subterranean formation having a temperature of up to about 320° F. In some embodiments, the present treatment fluids can be used in a subterranean formation having a temperature ranging between about 175° F. and about 350° F. In some embodiments, the present treatment fluids can be used in a subterranean formation having a temperature ranging between about 200° F. and about 350° F. In some embodiments, the present treatment fluids can be used in a subterranean formation having a temperature ranging between about 250° F. and about 350° F. In some embodiments, the present treatment fluids can be used in a subterranean formation having a temperature ranging between about 275° F. and about 350° F. In some embodiments, the present treatment fluids can be used in a subterranean formation having a temperature ranging between about 300° F. and about 350° F. In some embodiments, the present treatment fluids can be used in a subterranean formation having a temperature ranging between about 320° F. and about 350° F.

In some embodiments, gels made by the present invention can keep their integrity for at least about 3 days when used in a subterranean formation having a temperature of up to about 350° F. In certain embodiments, gels made by the present invention can keep their integrity for at least about 2 days when used in a subterranean formation having a temperature of up to about 350° F. In various embodiments, gels made by the present invention essentially fully degrade in at least about 6 days when used in a subterranean formation having a temperature of up to about 350° F. In some embodiments, gels made by the present invention essentially fully degrade in at least about 4 days when used in a subterranean formation having a temperature of up to about 350° F. In certain embodiments, “essentially fully degrade” means that the percentage of gellation has dropped below about 10%.

Depending on the function that the present treatment fluids are performing, one having ordinary skill in the art will be able to determine an appropriate length of time for the gel to remain in the subterranean formation prior to being broken. In some embodiments, gels formed from the present treatment fluids can be broken after the gel has been in the subterranean formation for at least about one day. In some embodiments, the gel can be broken after at least about two days in the subterranean formation, or after at least about three days in the subterranean formation, or after at least about four days in the subterranean formation, or after at least about five days in the subterranean formation, or after at least about seven days in the subterranean formation, or after at least about ten days in the subterranean formation, or after at least about fifteen days in the subterranean formation. In some embodiments, the gel can be broken after being in the subterranean formation for a time ranging between about one day and about two days, or between about two days and about three days, or between about three days and about four days, or between about four days and about five days, or between about five days and about seven days, or between about seven days and about ten days, or between about ten days and about fifteen days. The foregoing ranges represent the native break rate of the gel without adding an external breaker.

In some subterranean operations, it can be desirable to leave the gels in the subterranean formation for a shorter length of time. In some embodiments, gels formed from present treatment fluids can be allowed to remain in the subterranean formation for less than about one day. For example, the gels can be allowed to remain in the subterranean formation for about 16 hours or less, or about 14 hours or less, or about 12 hours or less, or about 10 hours or less, or about 8 hours or less, or about 6 hours or less, or about 4 hours or less, or about 2 hours or less before being broken.

The treatment fluids of the present invention may be prepared by any method suitable for a given application. For example, certain components of the treatment fluid of the present invention may be provided in a pre-blended powder or a dispersion of powder in a nonaqueous liquid, which may be combined with the aqueous base fluid at a subsequent time. After the pre-blended liquids and the aqueous base fluid have been combined polymerization initiators and other suitable additives may be added prior to introduction into the wellbore. Those of ordinary skill in the art, with the benefit of this disclosure will be able to determine other suitable methods for the preparation of the treatments fluids of the present invention.

In an exemplary embodiment, a method of making a wellbore treatment fluid includes: forming an acid internal/oil external emulsified fluid, wherein the emulsified fluid comprises an oil based fluid, an aqueous fluid, an emulsifier, and an acid; forming a nanoparticle clay fluid, wherein the fluid comprises a nanoparticle clay, a gelling agent, and a crosslinking agent; and combining the emulsified fluid and the nanoparticle clay fluid to form a treatment fluid.

In several embodiments, an acid/oil emulsion is formed by coating a proppant with an oil, adding an acid solution; adding an emulsifier, and combining all of the components.

In many embodiments, a nanoparticle clay fluid may be formed by hydrating a gelling agent, followed by the addition of a nanoparticle clay to the hydrated gel. After hydration of the hydrated gel while mixing, a crosslinking agent and buffer may be added.

In some embodiments, a method of treating in a subterranean formation includes pumping an emulsion fluid into the well first, followed by the nanoparticle fluid. Upon breaking the emulsion fluid, it will release the acid and break nanoparticle fluid as it flows back. An embodiment of method in more detail includes forming an acid internal/oil external emulsified fluid, wherein the emulsified fluid comprises an oil based fluid, an aqueous fluid, an emulsifier, and an acid; forming a nanoparticle clay fluid, wherein the fluid comprises a nanoparticle clay, a gelling agent, and a crosslinking agent; introducing the acid internal/oil external emulsified fluid into the subterranean formation; introducing the nanoparticle clay fluid into the subterranean formation, wherein the nanoparticle clay fluid is introduced into the formation after the acid internal/oil external emulsified fluid; breaking the acid internal/oil external emulsion fluid that has been introduced into the formation, thereby releasing the acid; and breaking the introduced nanoparticle clay fluid with the released acid.

In still another exemplary embodiment, the separate introduction of at least two of the treatment fluid components may be achieved by introducing the components within a single flowpath, but being separated by a spacer. Such a spacer may comprise a highly viscous fluid which substantially or entirely prevents the intermingling of the treatment fluid components while being pumped into a wellbore. Such spacers and methods of using the same are generally known to those of ordinary skill in the art.

In various embodiments, systems configured for delivering the treatment fluids described herein to a downhole location are described. In various embodiments, the systems can comprise a pump fluidly coupled to a tubular, the tubular containing the treatment fluids disclosed herein.

A wellbore treatment system may include an apparatus including a pump and a mixer to form an acid internal/oil external emulsified fluid, wherein the emulsified fluid comprises an oil based fluid, an aqueous fluid, an emulsifier, and an acid; form a nanoparticle clay fluid, wherein the fluid comprises a nanoparticle clay, a gelling agent, and a crosslinking agent; combine the emulsified fluid and the nanoparticle clay fluid to form a treatment fluid; and introduce the treatment fluid into the subterranean formation.

The pump may be a high pressure pump in some embodiments. As used herein, the term “high pressure pump” will refer to a pump that is capable of delivering a fluid downhole at a pressure of about 1000 psi or greater. A high pressure pump may be used when it is desired to introduce the treatment fluid to a subterranean formation at or above a fracture gradient of the subterranean formation, but it may also be used in cases where fracturing is not desired. In some embodiments, the high pressure pump may be capable of fluidly conveying particulate matter, such as proppant particulates, into the subterranean formation. Suitable high pressure pumps will be known to one having ordinary skill in the art and may include, but are not limited to, floating piston pumps and positive displacement pumps.

In other embodiments, the pump may be a low pressure pump. As used herein, the term “low pressure pump” will refer to a pump that operates at a pressure of about 1000 psi or less. In some embodiments, a low pressure pump may be fluidly coupled to a high pressure pump that is fluidly coupled to the tubular. That is, in such embodiments, the low pressure pump may be configured to convey the treatment fluid to the high pressure pump. In such embodiments, the low pressure pump may “step up” the pressure of the treatment fluid before it reaches the high pressure pump.

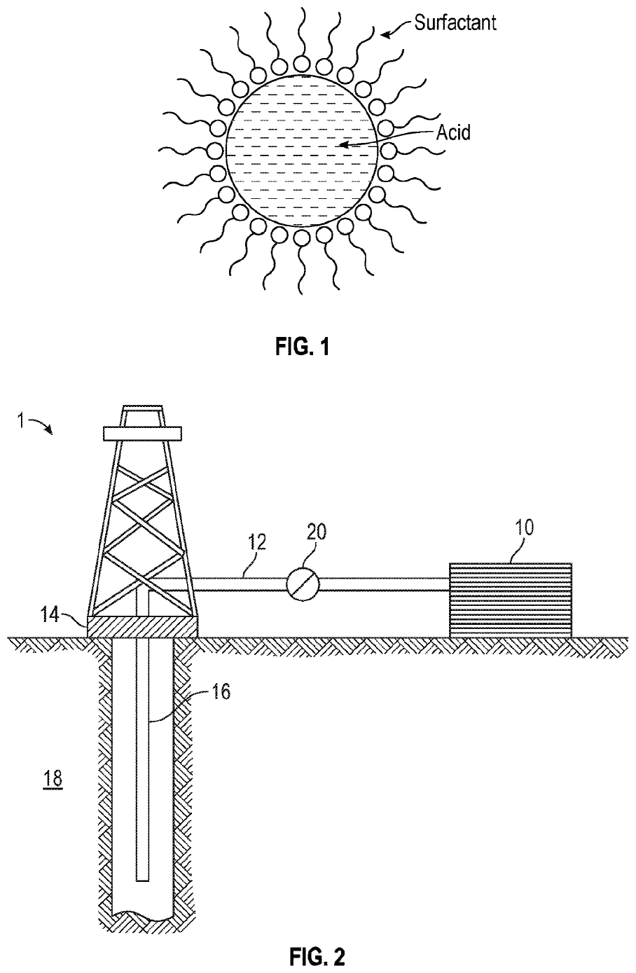

In embodiments, the disclosed wellbore treatment fluid may be prepared at a well site or at an offsite location. Once prepared, a treatment fluid of the present disclosure may be placed in a tank, bin, or other container for storage and/or transport to the site where it is to be used. In other embodiments, a treatment fluid of the present disclosure may be prepared on-site, for example, using continuous mixing, on-the-fly mixing, or real-time mixing methods. In certain embodiments, these methods of mixing may include methods of combining two or more components wherein a flowing stream of one element is continuously introduced into flowing stream of another component so that the streams are combined and mixed while continuing to flow as a single stream as part of the on-going treatment. The system depicted in FIG. 2 (described further below) may be one embodiment of a system and equipment used to accomplish on-the-fly or real-time mixing.

In some embodiments, the systems described herein can further comprise a mixing tank that is upstream of the pump and in which the treatment fluid is formulated. In various embodiments, the pump (e.g., a low pressure pump, a high pressure pump, or a combination thereof) may convey the treatment fluid from the mixing tank or other source of the treatment fluid to the tubular. In other embodiments, however, the treatment fluid can be formulated offsite and transported to a worksite, in which case the treatment fluid may be introduced to the tubular via the pump directly from its shipping container (e.g., a truck, a railcar, a barge, or the like) or from a transport pipeline. In either case, the treatment fluid may be drawn into the pump, elevated to an appropriate pressure, and then introduced into the tubular for delivery downhole.

FIG. 2 shows an illustrative schematic of a system that can deliver treatment fluids of the embodiments disclosed herein to a downhole location, according to one or more embodiments. It should be noted that while FIG. 2 generally depicts a land-based system, it is to be recognized that like systems may be operated in subsea locations as well. As depicted in FIG. 2, system 1 may include mixing tank 10, in which a treatment fluid of the embodiments disclosed herein may be formulated. The treatment fluid may be conveyed via line 12 to wellhead 14, where the treatment fluid enters tubular 16, tubular 16 extending from wellhead 14 into subterranean formation 18. Upon being ejected from tubular 16, the treatment fluid may subsequently penetrate into subterranean formation 18. Pump 20 may be configured to raise the pressure of the treatment fluid to a desired degree before its introduction into tubular 16. It is to be recognized that system 1 is merely exemplary in nature and various additional components may be present that have not necessarily been depicted in FIG. 2 in the interest of clarity. Non-limiting additional components that may be present include, but are not limited to, supply hoppers, valves, condensers, adapters, joints, gauges, sensors, compressors, pressure controllers, pressure sensors, flow rate controllers, flow rate sensors, temperature sensors, and the like.

Although not depicted in FIG. 2, the treatment fluid may, in some embodiments, flow back to wellhead 14 and exit subterranean formation 18. In some embodiments, the treatment fluid that has flowed back to wellhead 14 may subsequently be recovered and recirculated to subterranean formation 18.

It is also to be recognized that the disclosed treatment fluids may also directly or indirectly affect the various downhole equipment and tools that may come into contact with the treatment fluids during operation. Such equipment and tools may include, but are not limited to, wellbore casing, wellbore liner, completion string, insert strings, drill string, coiled tubing, slickline, wireline, drill pipe, drill collars, mud motors, downhole motors and/or pumps, surface-mounted motors and/or pumps, centralizers, turbolizers, scratchers, floats (e.g., shoes, collars, valves, etc.), logging tools and related telemetry equipment, actuators (e.g., electromechanical devices, hydromechanical devices, etc.), sliding sleeves, production sleeves, plugs, screens, filters, flow control devices (e.g., inflow control devices, autonomous inflow control devices, outflow control devices, etc.), couplings (e.g., electro-hydraulic wet connect, dry connect, inductive coupler, etc.), control lines (e.g., electrical, fiber optic, hydraulic, etc.), surveillance lines, drill bits and reamers, sensors or distributed sensors, downhole heat exchangers, valves and corresponding actuation devices, tool seals, packers, cement plugs, bridge plugs, and other wellbore isolation devices, or components, and the like. Any of these components may be included in the systems generally described above and depicted in FIG. 2.

The invention having been generally described, the following examples are given as particular embodiments of the invention and to demonstrate the practice and advantages hereof. It is understood that the examples are given by way of illustration and are not intended to limit the specification or the claims to follow in any manner.

### Examples

Emulsion Formation and Stability

Compositions:
UNIFRAC™ 20/40 hydraulic fracturing sand has a size in the range of from 20 mesh to 40 mesh available from Unimin Corporation—Energy Division, Woodlands, Tex.
ESCAID 110™ oil is a light hydrotreated petroleum distillate/mineral oil, available from ExxonMobil Chemical Company, Spring, Tex.
EZ MUL NT™ emulsifier is a polyaminated fatty acid available from Halliburton Energy Services, Houston, Tex.
WG-39™ gelling agent is a charged polymeric gelling agent available from Halliburton Energy Services, Houston, Tex.
THERMA-VIS™ viscosifier is a synthetic Hectorite available from Halliburton Energy Services, Houston, Tex.
BA20™ buffering agent is available from Halliburton Energy Services, Houston, Tex.
CL-23™ delayed-crosslinking agent is available from Halliburton Energy Services, Houston, Tex.

Experimental procedure:

The emulsion was formulated as follows:
1. Coat 36 gm (6 lb/gal) 20/40 UNIFRAC™ Sand with 2.64 mL ESCAID 110™.
2. Add 47.46 mL 2.5% HCl solution; and 0.5 mL (10 gal/1000 gal) EZ MUL NT™. The oil to acid water ratio was 1:20 by volume.

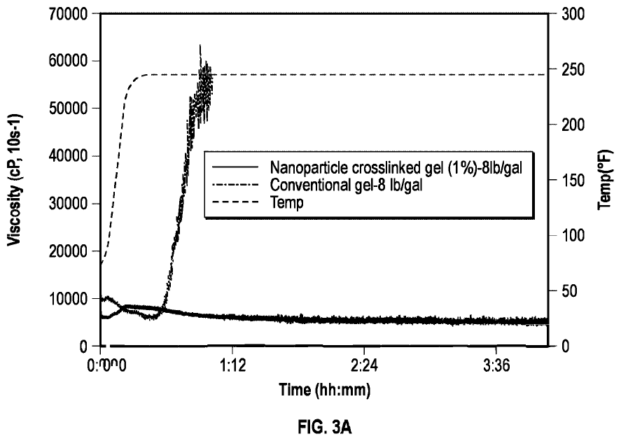

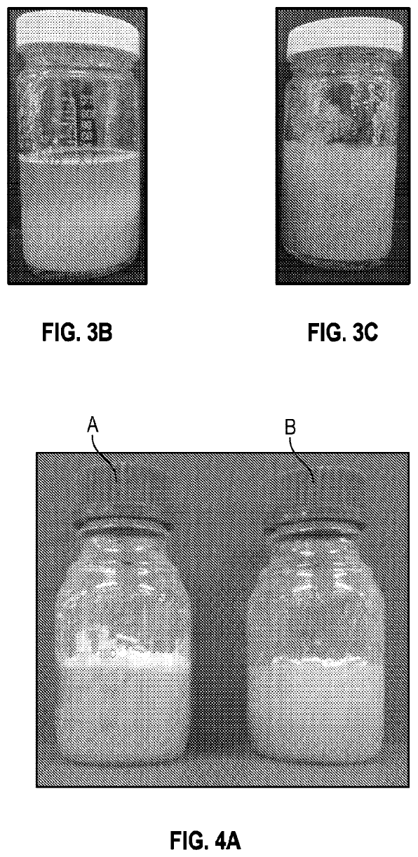

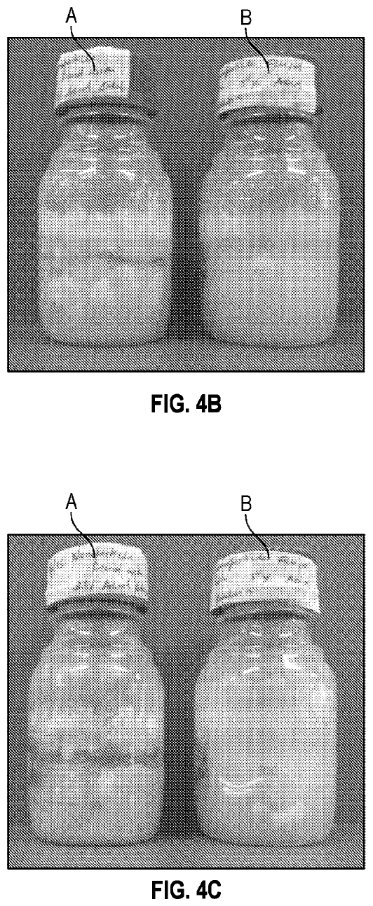

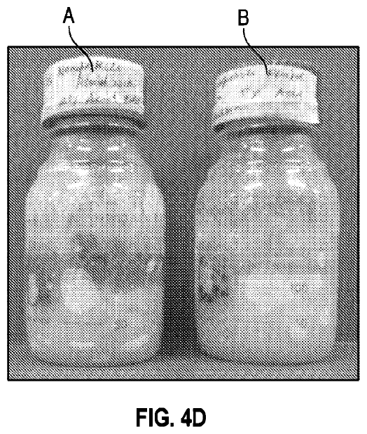

The nanoparticle clay fluid was formulated as follows:
1. Hydration of 40 lb/1000 gal WG-39™ gelling agent, followed by addition of 1% (w/v) THERMA-VIS™ viscosifier in hydrated gel. Mixture was left at 1500 rpm for complete hydration for 20 min
2. Gel was crosslinked using 1 gal/1000 gal BA-20™ buffering agent and 0.5 gal/1000 gal CL-23™ delayed-crosslinking agent.
3. Formulated nanoparticle gel showed excellent stability and proppant transport at higher temperature. FIG. 3A shows proppant transport of nanoparticle at 250° F. by using a Mimic™ device, available from Halliburton Energy Services, Inc., Houston, Tex. The Mimic™ device and methods of using the device are described in U.S. Pat. No. 6,782,735, issued Aug. 31, 2014. FIG. 3B is a photograph of the 8 lb/gal, 20/40 conventional gel in a broken state used in the plot in FIG. 3A. FIG. 3C is a photograph of a crosslinked (1%) 8 lb/gal, 20/40 gel in an unbroken state according to fluids of the disclosure and used in the plot in FIG. 3A.
4. A pre-formulated acid emulsion (5 mL or 20 mL) was layered on top of nanoparticle fluid (100 mL). A static break test was performed on the mixture at 200° F. Fluid A is a nanoparticle clay fluid with a 20% v/v acid emulsion. Fluid B is a nanoparticle clay fluid with a 5% v/v acid emulsion. FIGS. 4A-4D are photographs of each of fluid A and fluid B used in the static break test at the start (FIG. 4A), after 21 hours (FIG. 4B), after 24 hours (FIG. 4C), and after 40 hours (FIG. 4D). The experimental results show that use of 20% v/v acid-emulsion can break the fluid completely in 40 hours, as illustrated in FIG. 4D.

One of skill in the art may conclude that controlled breaker disclosed herein for nanoparticle clay fluids provides long term proppant suspension before fracture closure. The clean break provides for minimal formation and proppant pack damage. Further, the use of an acid as a breaker may generate microfractures for additional hydrocarbon flow.

Embodiments disclosed herein include:

A: A method of treating in a subterranean formation comprising: forming an acid internal/oil external emulsified fluid, wherein the emulsified fluid comprises an oil based fluid, an aqueous fluid, an emulsifier, and an acid; forming a nanoparticle clay fluid, wherein the fluid comprises a nanoparticle clay, a gelling agent, and a crosslinking agent; combining the emulsified fluid and the nanoparticle clay fluid to form a treatment fluid; introducing the treatment fluid into the subterranean formation; breaking the acid internal/oil external emulsion fluid portion of the treatment fluid, thereby releasing the acid, wherein the breaking occurs after introducing the treatment fluid into the formation; and breaking the nanoparticle clay fluid portion of the treatment fluid with the released acid.

B: A method of forming a wellbore fluid comprising: forming an acid internal/oil external emulsified fluid, wherein the emulsified fluid comprises an oil based fluid, an aqueous fluid, an emulsifier, and an acid; forming a nanoparticle clay fluid, wherein the fluid comprises a nanoparticle clay, a gelling agent, and a crosslinking agent; and combining the emulsified fluid and the nanoparticle clay fluid to form a treatment fluid.

C: A well treatment fluid comprising an acid internal/oil external emulsified fluid, wherein the emulsified fluid comprises an oil based fluid, an aqueous fluid, an emulsifier, and an acid; and a nanoparticle clay fluid, wherein the fluid comprises a nanoparticle clay, a gelling agent, and a crosslinking agent.

D: A method of treating in a subterranean formation comprising: forming an acid internal/oil external emulsified fluid, wherein the emulsified fluid comprises an oil based fluid, an aqueous fluid, an emulsifier, and an acid; forming a nanoparticle clay fluid, wherein the fluid comprises a nanoparticle clay, a gelling agent, and a crosslinking agent; introducing the acid internal/oil external emulsified fluid into the subterranean formation; introducing the nanoparticle clay fluid into the subterranean formation, wherein the nanoparticle clay fluid is introduced into the formation after the acid internal/oil external emulsified fluid; breaking the acid internal/oil external emulsion fluid that has been introduced into the formation, thereby releasing the acid; and breaking the introduced nanoparticle clay fluid with the released acid.

E: A well treatment system comprising: an apparatus including a pump and a mixer to form an acid internal/oil external emulsified fluid, wherein the emulsified fluid comprises an oil based fluid, an aqueous fluid, an emulsifier, and an acid; form a nanoparticle clay fluid, wherein the fluid comprises a nanoparticle clay, a gelling agent, and a crosslinking agent; combine the emulsified fluid and the nanoparticle clay fluid to form a treatment fluid; and introduce the treatment fluid into the subterranean formation.

Each of embodiments A, B, C D, and E may have one or more of the following additional elements in any combination: Element 1: wherein the acid internal/oil external emulsified fluid further comprises a proppant. Element 2: wherein no external breakers are used. Element 3: wherein the nanoparticle clay comprises at least one of hectorite, bentonite, and combinations thereof. Element 4: wherein the oil base fluid comprises at least one of esters prepared from fatty acids and alcohols; esters prepared from olefins and fatty acids; esters prepared from olefins and alcohols; linear alpha olefins; isomerized olefins having a straight chain; olefins having a branched structure; isomerized olefins having a cyclic structure; olefin hydrocarbons; linear paraffins; branched paraffins; poly-branched paraffins; cyclic paraffins; isoparaffins; mineral oil hydrocarbons; glyceride triesters; naphthenic compounds; diesel; aliphatic ethers prepared from long chain alcohols; aliphatic acetals; dialkylcarbonates; and combinations thereof. Element 5: wherein the proppant is at least one selected from the group consisting of sand; bauxite; ceramic materials; glass materials; polymer materials; nut shell pieces; cured resinous particulates comprising nut shell pieces; seed shell pieces; cured resinous particulates comprising seed shell pieces; fruit pit pieces; cured resinous particulates comprising fruit pit pieces; wood; composite particulates; hydrophobically modified proppants, inherently hydrophobic proppants, proppants with a hydrophobic coating; and any combination thereof. Element 6: wherein the acid is at least one selected from the group consisting of HCl, citric acid, citrates, fumaric acid, glycolic acid, salicylic acid, maleic acid, acetic acid, propionic acid, butanoic acid, pentanoic acid, hexanoic acid, heptanoic acid, octanoic acid, nonanoic acid, decanoic acid, dodecanoic acid, palmitic acid, stearic acid, sebacic acid, phthalic acid, isophthalic acid, terephthalic acid, adipic acid, pamoic acid, suberic acid, succinic acid, traumatic acid, thapsic acid, valporic acid, HEDTA, GLDA, MGDA, HIDS, EDDS, IDA, phosphonic acids, malonic acid, gluconic acid, lactic acid, methane sulfonic acid, fluoroboric acid, hydrochloride salts, glycine hydrochloride, N-Phosphonomethyl Iminodiacetic Acid (PMIDA), sulfonated esters, phosphate esters, organo orthoformate, organo orthoacetate, triethyl citrate, and combinations thereof. Element 7: wherein the acid has a pKₐ of from about −3.0 to about 5.5. Element 8: wherein the subterranean formation comprises at least one fracture and wherein the introducing further comprises placing at least a portion of the treatment fluid into the at least one fracture. Element 9: wherein the breaking of the acid internal/oil external emulsion fluid portion of the treatment fluid is triggered by the downhole temperature. Element 10: wherein the method is used in at least one of a fracturing operation, a gravel packing operation, and combinations thereof.

The particular embodiments disclosed above are illustrative only, as the present disclosure may be modified and practiced in different but equivalent manners apparent to those skilled in the art having the benefit of the teachings herein. Furthermore, no limitations are intended to the details of construction or design herein shown, other than as described in the claims below. It is therefore evident that the particular illustrative embodiments disclosed above may be altered or modified and all such variations are considered within the scope and spirit of the present disclosure. While compositions and methods are described in terms of “comprising,” “containing,” or “including” various components or steps, the compositions and methods can also “consist essentially of” or “consist of” the various components and steps. All numbers and ranges disclosed above may vary by some amount. Whenever a numerical range with a lower limit and an upper limit is disclosed, any number and any included range falling within the range is specifically disclosed. In particular, every range of values (of the form, “from about a to about b,” or, equivalently, “from approximately a to b,” or, equivalently, “from approximately a-b”) disclosed herein is to be understood to set forth every number and range encompassed within the broader range of values. Also, the terms in the claims have their plain, ordinary meaning unless otherwise explicitly and clearly defined by the patentee. Moreover, the indefinite articles “a” or “an”, as used in the claims, are defined herein to mean one or more than one of the element that it introduces. If there is any conflict in the usages of a word or term in this specification and one or more patent or other documents, the definitions that are consistent with this specification should be adopted.

Numerous other modifications, equivalents, and alternatives, will become apparent to those skilled in the art once the above disclosure is fully appreciated. It is intended that the following claims be interpreted to embrace all such modifications, equivalents, and alternatives where applicable.

What is claimed is:

1. A method of treating in a subterranean formation comprising:
forming an acid internal/oil external emulsified fluid, wherein the emulsified fluid comprises an oil based fluid, an aqueous fluid, an emulsifier, and an acid;
forming a nanoparticle clay fluid, wherein the fluid comprises a nanoparticle clay, a gelling agent, and a crosslinking agent;
combining the emulsified fluid and the nanoparticle clay fluid to form a treatment fluid;
introducing the treatment fluid into the subterranean formation;
breaking the acid internal/oil external emulsion fluid portion of the treatment fluid, thereby releasing the acid, wherein the breaking occurs after introducing the treatment fluid into the formation; and
breaking the nanoparticle clay fluid portion of the treatment fluid with the released acid.

2. The method of claim 1, wherein the acid internal/oil external emulsified fluid further comprises a proppant.

3. The method of claim 1, wherein no external breakers are used.

4. The method of claim 1, wherein the nanoparticle clay comprises at least one of hectorite, bentonite, and combinations thereof.

5. The method of claim 1, wherein the oil base fluid comprises at least one of esters prepared from fatty acids and alcohols; esters prepared from olefins and fatty acids; esters prepared from olefins and alcohols; linear alpha olefins; isomerized olefins having a straight chain; olefins having a branched structure; isomerized olefins having a cyclic structure; olefin hydrocarbons; linear paraffins; branched paraffins; poly-branched paraffins; cyclic paraffins; isoparaffins; mineral oil hydrocarbons; glyceride triesters; naphthenic compounds; diesel; aliphatic ethers prepared from long chain alcohols; aliphatic acetals; dialkylcarbonates; and combinations thereof.

6. The method of claim 2, wherein the proppant is at least one selected from the group consisting of sand; bauxite; ceramic materials; glass materials; polymer materials; nut shell pieces; cured resinous particulates comprising nut shell pieces; seed shell pieces; cured resinous particulates comprising seed shell pieces; fruit pit pieces; cured resinous particulates comprising fruit pit pieces; wood; composite particulates; hydrophobically modified proppants, inherently hydrophobic proppants, proppants with a hydrophobic coating; and any combination thereof.

7. The method of claim 1, wherein the acid is at least one selected from the group consisting of HCl, citric acid, citrates, fumaric acid, glycolic acid, salicylic acid, maleic acid, acetic acid, propionic acid, butanoic acid, pentanoic acid, hexanoic acid, heptanoic acid, octanoic acid, nonanoic acid, decanoic acid, dodecanoic acid, palmitic acid, stearic acid, sebacic acid, phthalic acid, isophthalic acid, terephthalic acid, adipic acid, pamoic acid, suberic acid, succinic acid, traumatic acid, thapsic acid, valporic acid, HEDTA, GLDA, MGDA, HIDS, EDDS, IDA, phosphonic acids, malonic acid, gluconic acid, lactic acid, methane sulfonic acid, fluoroboric acid, hydrochloride salts, glycine hydrochloride, N-Phosphonomethyl Iminodiacetic Acid (PMIDA), sulfonated esters, phosphate esters, organo orthoformate, organo orthoacetate, triethyl citrate, and combinations thereof.

8. The method of claim 1, wherein the acid has a pKₐ of from about −3.0 to about 5.5.

9. The method of claim 1, wherein the subterranean formation comprises at least one fracture and wherein the introducing further comprises placing at least a portion of the treatment fluid into the at least one fracture.

10. The method of claim 1, wherein the breaking of the acid internal/oil external emulsion fluid portion of the treatment fluid is triggered by the downhole temperature.

11. The method of claim 1, wherein the method is used in at least one of a fracturing operation, a gravel packing operation, and combinations thereof.

12. A method of forming a wellbore treatment fluid comprising:
forming an acid internal/oil external emulsified fluid, wherein the emulsified fluid comprises an oil based fluid, an aqueous fluid, an emulsifier, and an acid;
forming a nanoparticle clay fluid, wherein the fluid comprises a nanoparticle clay, a gelling agent, and a crosslinking agent; and
combining the emulsified fluid and the nanoparticle clay fluid to form a treatment fluid.

13. The method of claim 12, wherein the acid internal/oil external emulsified fluid further comprises a proppant.

14. The method of claim 12, wherein no external breakers are used.

15. The method of claim 12, wherein the nanoparticle clay comprises at least one of hectorite, bentonite, and combinations thereof.

16. The method of claim 12, wherein the oil base fluid comprises at least one of esters prepared from fatty acids and alcohols; esters prepared from olefins and fatty acids; esters prepared from olefins and alcohols; linear alpha olefins; isomerized olefins having a straight chain; olefins having a branched structure; isomerized olefins having a cyclic structure; olefin hydrocarbons; linear paraffins; branched paraffins; poly-branched paraffins; cyclic paraffins; isoparaffins; mineral oil hydrocarbons; glyceride triesters; naphthenic compounds; diesel; aliphatic ethers prepared from long chain alcohols; aliphatic acetals; dialkylcarbonates; and combinations thereof.

17. The method of claim 13, wherein the proppant is at least one selected from the group consisting of sand; bauxite; ceramic materials; glass materials; polymer materials; nut shell pieces; cured resinous particulates comprising nut shell pieces; seed shell pieces; cured resinous particulates comprising seed shell pieces; fruit pit pieces; cured resinous particulates comprising fruit pit pieces; wood; composite particulates; hydrophobically modified proppants, inherently hydrophobic proppants, proppants with a hydrophobic coating; and any combination thereof.

18. The method of claim 12, wherein the acid is at least one selected from the group consisting of HCl, citric acid, citrates, fumaric acid, glycolic acid, salicylic acid, maleic acid, acetic acid, propionic acid, butanoic acid, pentanoic acid, hexanoic acid, heptanoic acid, octanoic acid, nonanoic acid, decanoic acid, dodecanoic acid, palmitic acid, stearic acid, sebacic acid, phthalic acid, isophthalic acid, terephthalic acid, adipic acid, pamoic acid, suberic acid, succinic acid, traumatic acid, thapsic acid, valporic acid, HEDTA, GLDA, MGDA, HIDS, EDDS, IDA, phosphonic acids, malonic acid, gluconic acid, lactic acid, methane sulfonic acid, fluoroboric acid, hydrochloride salts, glycine hydrochloride, N-Phosphonomethyl Iminodiacetic Acid (PMIDA), sulfonated esters, phosphate esters, organo orthoformate, organo orthoacetate, triethyl citrate, and combinations thereof.

19. The method of claim 12, wherein the acid has a pKₐ of from about −3.0 to about 5.5.

20. The method of claim 12, wherein the subterranean formation comprises at least one fracture and wherein the introducing further comprises placing at least a portion of the treatment fluid into the at least one fracture.

21. The method of claim 12, wherein the breaking of the acid internal/oil external emulsion fluid portion of the treatment fluid is triggered by the downhole temperature.

22.-31. (canceled)
